(19) United States
(12) Patent Application Publication
(10) Pub. No.: US 2019/0109395 A1
(43) Pub. Date: Apr. 11, 2019

(54) ELECTRICAL TERMINAL

(71) Applicant: Phoenix Contact GmbH & Co. KG, Blomberg (DE)

(72) Inventors: Ralf Geske, Schieder-Schwalenberg (DE); Dieter Holste, Detmold (DE); Ralf Gehle, Detmold (DE)

(73) Assignee: Phoenix Contact GmbH & Co. KG, Blomberg (DE)

(21) Appl. No.: 15/774,400

(22) PCT Filed: Nov. 10, 2016
(86) PCT No.: PCT/EP2016/077297

§ 371 Date: May 8, 2018

(30) Foreign Application Priority Data
Nov. 11, 2015 (DE) 10 2015119 478.3

(51) Int. Cl. H01R 13/11; H01R 4/48; H01R 13/506; H01R 12/71

(52) U.S. Cl. CPC H01R 13/11; H01R 12/712; H01R 13/506; H01R 4/4836

(57) ABSTRACT

An electric connection terminal includes a housing, a spring clip and a metal part. The spring clip has a clamping leg and a contact leg. The clamping leg, together with a portion of the metal part, forms a spring force clamping connection for an electrical conductor. The housing includes a conductor insertion opening for the electrical conductor to be connected, and an actuation opening for opening the spring force clamping connection. An electrical conductor can be easily connected to a circuit board with the electrical connection terminal by virtue of the metal part being electrically and mechanically connected to a plug contact via a connection region. The plug contact includes two contact legs, which are resilient relative to each other, for plugging into a contact hole of a circuit board.

### BACKGROUND OF THE INVENTION

### Field of the Invention

The invention relates to an electrical terminal with a housing, a spring clip and a metal part. More particularly, the invention relates to an electrical terminal in which a spring clip includes a clamping leg and a contact leg, the clamping leg and a section of a metal part forming a spring force clamp terminal for an electrical lead which is to be connected to the electrical terminal. Further, the housing includes a lead insertion opening for inserting the electrical lead and an actuating opening for opening the spring force clamp terminal.

Electrical terminals have been known for decades in a host of embodiments. The terminals can be made for example for connection to another lead as a terminal block or for connection of one electrical lead or several leads to a circuit board as a so-called printed terminal. Spring clips are both loop-shaped spring clips, so-called tension spring clamps, and also U-shaped or V-shaped spring clips into which rigid leads or leads provided with a wire end ferrule can be plugged directly, i.e., without the clamping site having to be opened beforehand with a tool. To connect flexible leads, the clamping site between the clamping leg and the busbar piece must be opened, for which an actuating opening in housing for insertion of a tool, for example the tip of a screwdriver. In known U-shaped or V-shaped spring clips, the lead to be connected is pressed by the clamping leg against the busbar piece.

### Description of Related Art

German Patent Application DE 10 2008 039 232 A1 discloses an electrical terminal which is intended as part of a terminal block. The known terminal has an actuating pusher which is movably located in an actuating opening made in the housing and with which the clamping site can be opened when the actuating pusher is pressed into the housing. By making an offset in the housing and a corresponding projection on the actuating pusher, the actuating pusher can be locked in the position which opens the clamping site so that the clamping site is kept in the opened position, as a result of which a flexible lead can be inserted into the electrical terminal without the need to continuously press the actuating pusher.

Similar terminals which are made as printed terminals are known from practice in various configurations. These printed terminals have corresponding contact pins which are forced or soldered into the contact holes in the circuit board. Both soldering and forcing have proven effective over the years as a technique for connecting circuit boards since they ensure good and permanent electrical contact between the contact partners, the contact pin and the contact hole. One disadvantage both of soldering and forcing is that the two joining techniques are not reversible so that a connection, once established, cannot be broken again or at least only with increased effort. Moreover additional working steps and/or special tools are necessary to establish the connection. Here plug-in connections which have been used for decades in other applications offer one alternative since the connection can be easily established and moreover can also be broken again by hand.

For some time a plug-in contact which was made for use in circuit boards has been known from practice. Specifically, a plug-in contact is made in the manner of a spring yoke, and has two flat contact legs which are resilient relative to one another and which are connected to one another via a common connecting region. An electrical terminal with several of these plug-in contacts is known from German Patent Application DE 10 2011 011 017 A1. The individual plug-in contacts are arranged in several rows next to one another in chambers of the adapter box such that the plug-in contacts extend vertically to the plane of the circuit board. To connect individual leads, the connecting regions are made as a crimp connection for the plug-in contacts. In this way, several leads can be connected to one circuit board in which the individual contact holes have a short distance to one another, but later connection or disconnection of individual leads is not possible in the known terminal. Instead, the leads must be connected to the plug-in contacts before the plug-in contacts are inserted into the chambers in the housing.

### SUMMARY OF THE INVENTION

Therefore, an object of this invention is to make available the initially described electrical terminal with which an electrical lead can be easily connected to a circuit board. The connection of a lead or the replacement of the lead should also be possible on site.

This and other objects are achieved by an electrical terminal with a metal part which is connected in an electrically conductive manner and mechanically to a plug-in contact via at least one connecting region, the plug-in contact having two contact legs which are resilient relative to one another for plugging into a corresponding contact hole in a circuit board.

Because the electrical terminal of the present invention has a spring force clamp terminal for connecting an electrical lead and has a plug-in contact for making contact with a circuit board, both the connection between the terminal and a circuit board can be easily established and also easily broken again, i.e. the two electrical connections and connection sites of the electrical terminal are made reversible. Since in the electrical terminal of the present invention the connection region of the plug-in contact intended for connection of the electrical lead is not made as a crimp connection, but as a spring force clamp terminal, the electrical terminal need not be prepared already with an electrical lead. Instead, the connection of the electrical lead can be also be undertaken on site or even after the terminal has been connected to the circuit board. Here, the spring clip is preferably a U-shaped or V-shaped spring clip so that a rigid lead or one provided with a wire end ferrule can be plugged directly into the clamping site.

The connecting region which connects the metal part to the plug-in contact can decouple from the spring force clamp terminal the forces which occur when the contact legs are being plugged in and withdrawn if the connecting region has a certain flexibility in the axial direction. This can be easily accomplished by the connecting region running at least partially vertically or obliquely to the longitudinal direction of the contact legs so that a small axial displacement of the contact legs does not lead directly to a corresponding axial displacement of the metal part. The metal part and the plug-in contact are preferably made integral with one another, in particular punched out of a metallic flat material and bent.

So that none of the forces which could damage the contact-making region with the circuit board are transferred when the electrical lead is being connected to the terminal, preferably mechanical decoupling of the forces which occur when the lead is being connected from the contact legs of the plug-in contact also takes place. According to one preferred configuration of the invention, for this purpose the housing is made in two parts, so that it has a first housing part and a second housing part, the first housing part being axially movable relative to the second housing part between a first position and a second position. Here the spring clip and the metal part are located in the first housing part, while the contact legs of the plug-in contact are located to be axially movable in a chamber formed in the second housing part in the longitudinal direction of the chamber.

The displacement of the contact legs of the plug-in contact in the chamber of the second housing part is effected by a displacement of the first housing part out of its first position into its second position, or vice versa, the direction of motion of the housing part and the direction of motion of the contact legs being the same. In the first position of the first housing part, the contact legs of the plug-in contact are in the chamber of the second housing part, and the free ends of the contact legs do not protrude from the bottom of the second housing part facing away from the first housing part. In the first position of the first housing part the contact legs of the plug-in contact are thus located protected within the second housing part. If the first housing part is moved out of its first position into its second position, not only does the first housing part move relative to the second housing part, but the contact legs within the chamber also move, and the free ends of the contact legs will protrude from the bottom of the second housing part when the first housing part is in its second position.

When the electrical terminal is being placed on a circuit board which has a contact hole which corresponds to the contact legs of the plug-in contact, the contact legs can be easily and reliably plugged into the contact hole in the circuit board by the first housing part being moved out of its first position into its second position after the terminal has been placed with the bottom of the second housing part on the circuit board. Since the contact legs are being guided in the chamber in the second housing part in doing so, canting of the contact legs during insertion into the contact hole in the circuit board is reliably prevented.

According to one preferred configuration, the axial displacement capacity between the two housing parts is reliably and easily implemented by the first housing part on the end facing the second housing part having a sleeve-shaped connecting region in which the second housing part is guided. The first housing part when moving out of its first position into its second position is pushed farther over the second housing part or the second housing part is pushed farther into the first housing part. On the first housing part at least one stop and on the second housing part at least one corresponding counterstop are made and arranged such that the stop in the second position of the first housing part adjoins the counterstop. This limits the maximum possible axial displacement of the first housing part relative to the second housing part.

Since the contact legs of the plug-in contact are likewise displaced axially by the axial movement of the first housing part out of its first position into its second position, the stop also establishes how far the free ends of the contact legs can protrude at most from the bottom of the second housing part. This can ensure that in the mounted state of the terminal with a circuit board the contact legs of the plug-in contact are located with a given contact region within the contact hole in the circuit board.

Preferably in the sleeve-shaped connecting region of the first housing part, at least one window is provided with an engaging projection which extends radially and which is made on the second housing part. If two windows are made in the sleeve-shaped connecting region on two opposite sides of the first housing part, the second housing part accordingly also has two projections.

According to one advantageous configuration, the at least one projection or both projections have a feed bevel and a step or edge. In the first position of the first housing part, the step of the projection adjoins the first edge of the window near the second housing part. Conversely, in the second position of the first housing part, the step is spaced apart from the first edge of the window. In this case, preferably the feed bevel of the projection adjoins the second edge of the window, which is farther away from the second housing part than the first edge of the window. The feed bevel facilitates the mounting or joining of the two housing parts. The axial displacement capacity of the first housing part is limited primarily by the already described stop on the first housing part and the corresponding counterstop on the second housing part. The stop on the first housing part can be easily implemented by the front side of the sleeve-shaped connecting region, i.e., the forward face of the first housing part, while the counterstop is formed by a corresponding collar or a step on the second housing part.

In order to prevent unwanted displacement of the first housing part out of the first position into the second position, the first housing part can be locked preferably in its first position on the second housing part. The locking between the two housing parts can be accomplished by making at least one locking lug and at least one corresponding locking recess, and the locking lug can be provided on the first housing part or on the second housing part and the locking recess which corresponds to it can then be provided accordingly on the second housing part or the first housing part. It is structurally especially simple if on the second housing part a locking lug which extends somewhat radially is made which adjoins the front side of the first housing part in the first position of the first housing part. The locking lug on the second housing part is made by making a corresponding bevel or by a step with a relatively small height such that the first housing part due to the elasticity of the sleeve-shaped connecting region and/or the locking lug can be pushed with little effort over the locking lug.

According to another especially preferred configuration of the invention, in the first housing part at least one stop is made and on the metal part at least one corresponding counterstop is made, as a result of which the metal part is fixed in its position in the first housing part. Forces which arise when a lead is being inserted are diverted in this way into the housing from the metal part so that they do not act on the contact region between the contact legs of the plug-in contact and the contact hole in a circuit board into which the contact legs are being plugged. The stop can be made for example as a projection in the first housing part which interacts with a corresponding edge of the metal part as the counterstop. In this way, axial displacement of the metal part when a lead is being plugged into the clamping site or when the clamping site is being opened is prevented. Alternatively, to the above described configuration, in the housing a corresponding recess can also be made which a projection made on the metal part engages. Making at least one stop and at least one corresponding counterstop ensures that when a lead is being connected or disconnected actuating forces acting on the metal part are not transferred to the circuit board.

For simple mounting of the electrical terminal on a circuit board, according to another advantageous configuration it is provided that on the bottom of the second housing part facing away from the first housing part at least one adjusting element is made which can be plugged into a corresponding recess in the circuit board. The free end of the adjusting element is made preferably conical, as a result of which the insertion of the adjusting element into the corresponding recess in the circuit board is facilitated. Making at least one adjusting element ensures pre-centering of the plug-in contact so that the contact legs of the plug-in contact are then plugged more easily and centered into the contact leg in the circuit board when the first housing part is being moved out of its first position into its second position.

In order to fix the electrical terminal in the plugged-in state on the circuit board, according to another advantageous configuration, it is provided that on the bottom of the second housing part at least one fixing element is made which is plugged into a corresponding recess in the circuit board. The fixing element can be, for example, a locking element which has locking lugs with which the housing of the electrical terminal can be reliably fixed on the circuit board. Alternatively, the at least one fixing element can also be made as a connection flange so that the housing can be screwed on a circuit board by means of a screw which is located in the connection flange. In doing so, the fixing element itself can also have the function of the aforementioned adjusting element by for example the front end of the fixing element being made conical.

According to another preferred configuration of the electrical terminal of the invention which is being briefly described here, the clamping site is not opened by means of a separate actuating tool which has been inserted into the actuation opening, for example, the tip of a screwdriver, but using an actuating pusher which is movably located in the actuation opening. The actuating pusher can be moved out of a first position in which the spring force clamp terminal is closed into a second position in which the actuating pusher with its end facing the clamping leg deflects the clamping leg against the spring force of the spring clip so that the spring force clamp terminal is opened. Then a connected lead can be easily withdrawn from the clamping site or a flexible lead can be inserted into the clamping site.

In particular, at this point there are various possibilities for configuring and developing the electrical terminal in accordance with the invention as will be apparent from the following description of preferred exemplary embodiments in conjunction with the drawings.

### BRIEF DESCRIPTION OF THE DRAWINGS

FIG. 1 shows a preferred exemplary embodiment of an electrical terminal in accordance with the present invention in a pre-locked position, in a longitudinal section,

FIG. 1a shows an enlarged detail of FIG. 1

FIGS. 2a & 2b show the electrical terminal according to FIG. 1, in the prelocked position and in the end position on a circuit board, respectively,

FIG. 3 shows an enlargement of a cutaway portion of the terminal according to FIG. 1,

FIG. 4 shows a perspective of the terminal according to FIG. 1, without the housing, and

FIG. 5 shows a perspective of a second version of a terminal, without the housing.

### DETAILED DESCRIPTION OF THE INVENTION

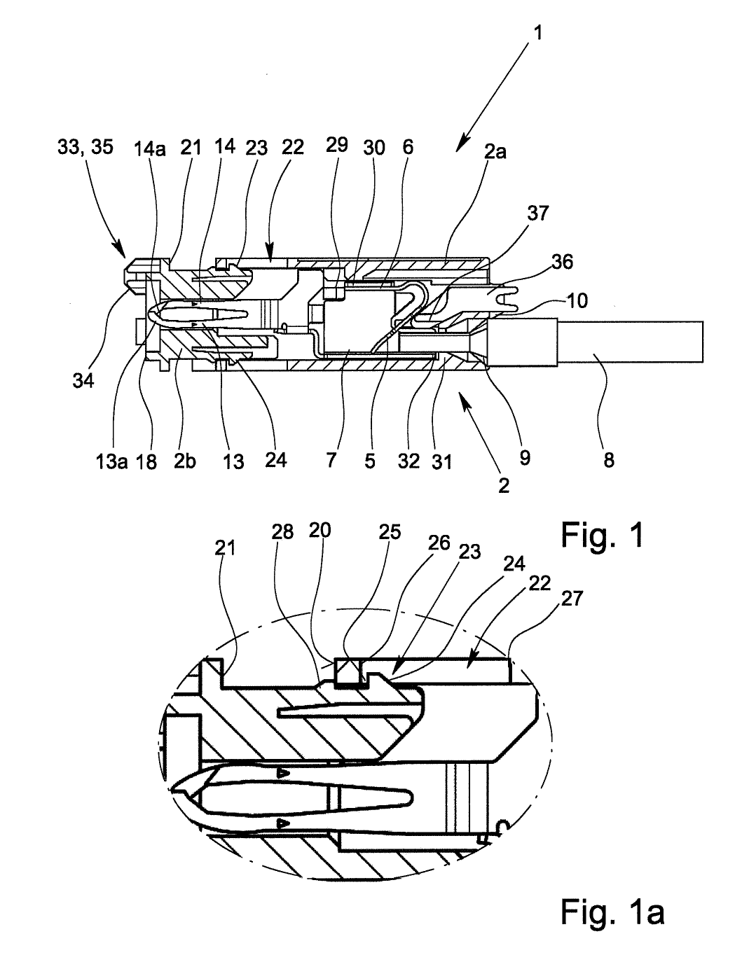

FIGS. 1 & 1a show a first preferred exemplary embodiment of an electrical terminal 1 of the invention with a plastic housing 2, the housing 2 being made in two parts, specifically a first housing part 2a and a second housing part 2b. In the first housing part 2a are a spring clip 3 and a metal part 4. The exemplary V-shaped spring clip 3 has one clamping leg 5 and one contact leg 6, the clamping leg 5 and one segment 7 of the metal part 4 forming a sprig force terminal connection for an electrical lead 8 which is to be connected. For this purpose, the lead 8 is pressed by the free end of the clamping leg 5 against the opposite side of the segment 7 of the metal part 4.

The housing 2 whose longitudinal extension runs in the connection direction of the lead 8 on one front side has a lead insertion opening 9 for inserting the electrical lead 8 which is to be connected, and also has an actuation opening 10 in which an actuating pusher for opening the clamping site is movably located. If the clamping site between the clamping leg 5 and the segment 7 is opened, i.e., the clamping leg 5 is deflected against the spring force of the spring clip 3, a connected lead 8 can be withdrawn from the clamping site and thus also from the terminal 1.

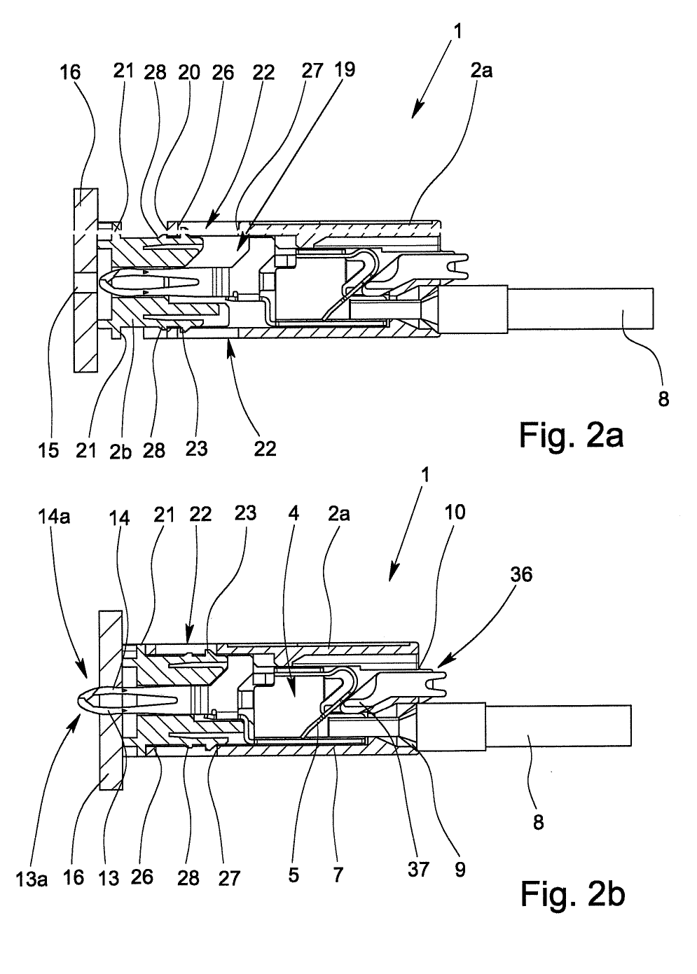

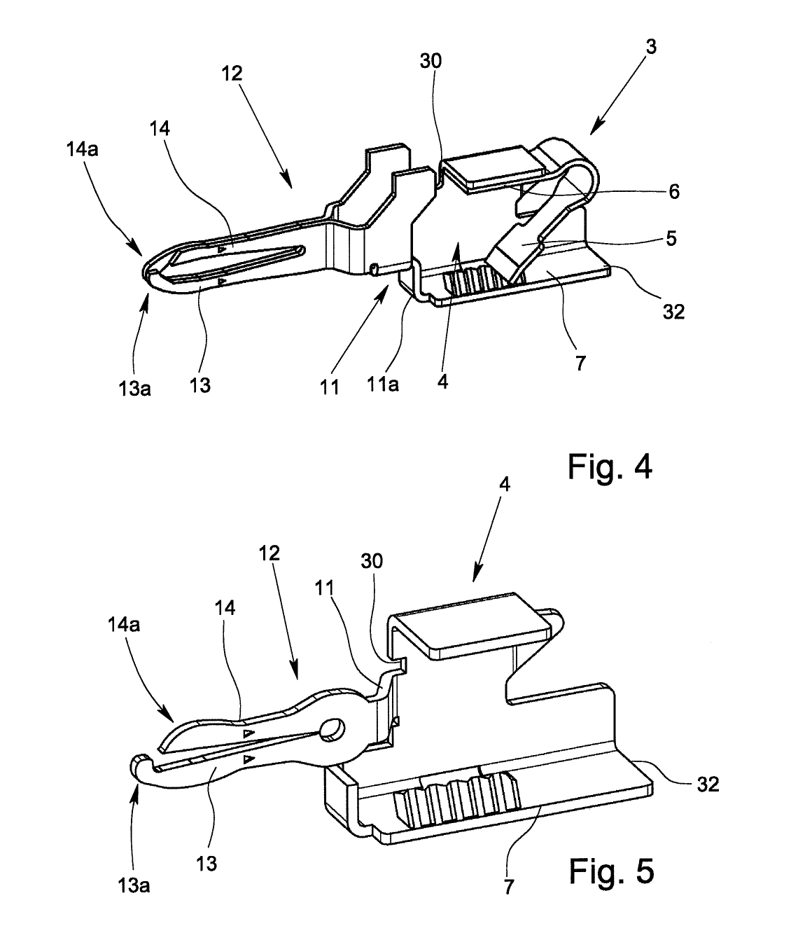

The exemplary U-shaped metal part 4 is electrically and mechanically connected via a connecting region 11 to a plug-in contact 12, the plug-in contact 12 having two contact legs 13, 14 which are resilient relative to one another. In the exemplary embodiment which is shown in FIG. 1, the connecting region 11 has two connecting bridges 11a, 11b which have a certain flexibility in the axial direction so that axial forces acting on the contact legs 13, 14 are transferred only reduced to the metal part 4. In the described exemplary embodiment, the metal part 4 and the plug-in contact 12 are punched out of a metallic flat material and bent so that the shape which is recognizable in particular in FIG. 4 results. The contact legs 13, 14 are used to plug into a contact hole 15 in a circuit board 16, as is apparent from FIG. 2.

FIGS. 2a and 2b furthermore show that the first housing part 2a can be moved axially relative to the second housing part 2b. FIG. 2a shows the first housing part 2a in the first position, the pre-locked position; while in FIG. 2b the first housing part 2a is in the second position. In the first position of the first housing part 2a the two contact legs 13, 14 of the plug-in contact 12 are in a chamber 17 formed in the second housing part 2b so that the contact legs 13, 14 are protected in the pre-locked position by the second housing part 2b. As is also apparent from FIG. 1, the free ends 13a, 14a of the contact legs 13, 14 in the first position of the first housing part 2a do not project beyond the bottom 18 of the second housing part 2b facing away from the first housing part 2a. This leads to the fact that when the electrical terminal 1 according to FIG. 2b in the pre-locked position is slipped on a circuit board 16, the free ends 13a, 14a of the contact legs 13, 14 still do not dip into the contact hole 15.

If, conversely, the first housing part 2a is moved out of its first position into its second position, as is shown in FIG. 2b, not only is the first housing part 2a moved relative to the second housing part 2b, but the plug-in contact 12 is also moved relative to the second housing part 2b so that then the free ends 13a, 14a of the contact legs 13, 14 protrude from the bottom 18 of the second housing part 2b. When the terminal 1 is placed on a circuit board, the free ends 13a, 14a dip into the contact hole 15 in the circuit board 16, as a result of which the plug-in contact 12 is connected in an electrically conductive manner to the circuit board 16.

The first housing part 2a on the end assigned to the second housing part 2b has a sleeve-shaped connecting region 19 in which the second housing part 2b is guided. The first housing part 2a, as is apparent from a comparison of FIGS. 2a and 2b, when moving out of the first position into the second position is thus pushed farther over the second housing part 2b in the direction of the circuit board 16. In order to limit the axial motion of the first housing part 2a relative to the second housing part 2b, on the first housing part 2a a stop is made which is formed by the front side 20 of the connecting region 19 or of the first housing part 2a. Corresponding thereto, the second housing part 2b has a collar 21 as the counterstop, in the second position of the first housing part 2a the front side 20 adjoining the collar 21.

In the sleeve-shaped connecting region 19 of the first housing part 2a on opposite sides of the housing part 2a, two windows 22 are moreover made which in the mounted state of the two housing parts 2a, 2b are engaged by a radially extending projection 23 of the second housing part 2b. The two projections 23 each have one feed bevel 24 and one step 25 which directly adjoins the feed bevel 24. The feed bevel 24 runs in the direction in which the first housing part 2a is slipped on so that due to the elasticity of the projections 23 and of the sleeve-shaped connecting region 19 the first housing part 2a for connection to the second housing part 2b can be easily slipped into the second housing part 2b over the feed bevel 24 into the prelocked position which is shown in FIG. 1 and FIG. 2a.

In the first position of the first housing part 2a, the projection 23 adjoins the first forward edge 26 of the window 22 with its step 25. In the second position of the first housing part 2a the step 25 is conversely spaced apart from the first edge 26 of the window 22. As is apparent from FIG. 2b, in the second position of the second housing part 2a the feed bevel 24 of the projection 23 adjoins the second rear edge 27 of the window 22. Making the window 22 in the connecting region 19 of the first housing part 2a and making the projections 23 and the collar 21 on the second housing part 2b thus ensures that the first housing part 2a can only be moved between the first position and the second position when being slipped on and withdrawn.

So that for the electrical terminal 1 the first housing part 2a remains reliably in the first position before mounting on a circuit board 16, there is locking between the two housing parts 2a, 2b. In the described preferred exemplary embodiment two somewhat radially extending locking lugs 28 are made on the second housing part 2b for this purpose. The two locking lugs 28 have a distance from the step 25 of the respectively assigned projection 23 which is somewhat greater than the distance between the front side 20 of the connecting region 19 and the first edge 26 of the window 22 which has been made in the connecting region 19. This section of the connecting region 19 in the first position of the first housing part 2a is thus located and locked between the step 25 of the projection 23 and the locking lug 28. So that intentional displacement of the first housing part 2a out of the first position into the second position is not associated with an overly great effort, the locking lug 28 has a relatively low height. In particular the height of the locking lug 28 is less than the height of the projection 23.

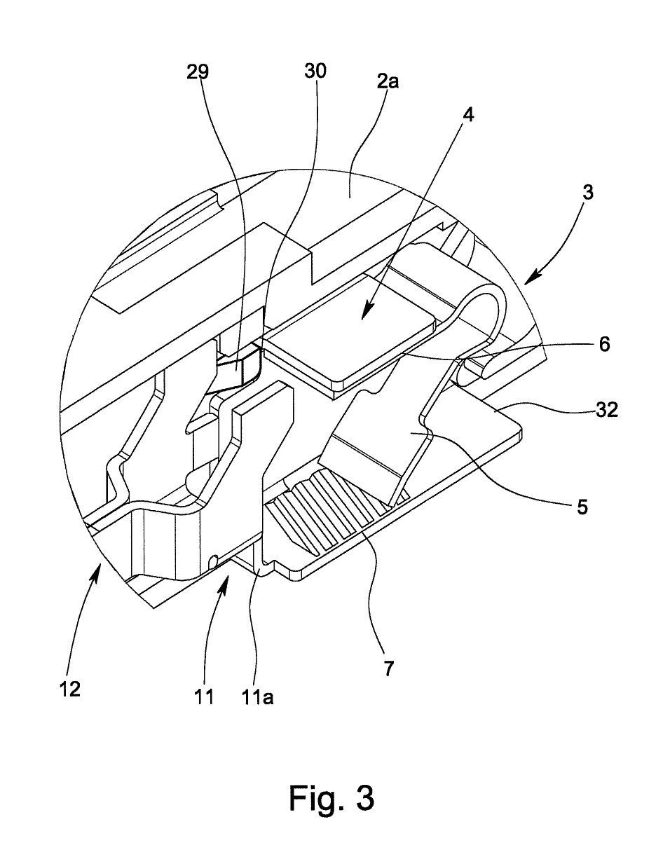

The enlargement of a cutaway portion of the terminal 1 according to FIG. 3 shows that in the first housing part 2a a projection 29 is made which is used as a stop for the metal part 4 and interacts with an edge 30 which is used as a counterstop on the metal part 4 so that the metal part 4 is fixed in its position within the first housing part 2a. This leads to the actuating forces which arise when a lead 8 is being plugged into the terminal 1 being diverted from the metal part 4 into the first housing part 2a so that these forces are not transferred to the contact region between the contact legs 13, 14 and the contact hole 15 or the circuit board 16. A second projection 31 made in the first housing part 2a provides for the metal part 4 also being fixed in its position when tensile forces are acting on an electrical lead 8 which has been inserted into the clamping site. The projection 31 in the first housing part 2a then interacts with a back second edge 32 of the metal part 4 so that tensile forces acting on a connected electrical lead 8 are not transferred to the contact site of the plug-in contact 12 either.

For simple mounting and fastening of the electrical terminal 1 on a circuit board 16, the second housing part 2b on its bottom 18 has at least one adjusting element 33 which can be plugged into a corresponding recess in the circuit board 16. The free end 34 of the adjusting element 33 is made conical, as a result of which the insertion of the adjusting element 33 into the corresponding recess in the circuit board 16 is facilitated. In the described exemplary embodiment, the adjusting element 33 is made as a connection flange 35 so that the housing 2 of the terminal 1 can be screwed on the circuit board 16 by means of a screw which is located in the connection flange 35. In addition to a combined adjusting and fixing element, as is implemented in the described exemplary embodiment, the second housing part 2b can also have individual adjusting elements and fixing elements which are separate from one another and which can be in turn connection flanges or even locking pins.

In order to be able to easily open the clamping site between the free end of the clamping leg 5 of the spring clip 3 and the opposite segment 7 of the metal part 4, an actuating presser 36 is movably located in the actuation opening 10. If the actuating pusher 36 is pushed out of the first position shown in the figures farther into the actuation opening 10 in the first housing part 2a, the end 37 of the actuating pusher 36 facing the clamping leg 5 deflects the clamping leg 5 against the spring force of the spring clip 3 so that the spring force clamp terminal is opened. Then an electrical lead 8 which was connected beforehand can be easily withdrawn from the clamping site or a flexible lead can be plugged into the clamping site.

FIG. 5 shows a metal part 4 and a plug-in contact 12 which is connected to it via the connecting region 11 and in which the configuration of the plug-in contact 12 differs somewhat from the plug-in contact 12 which is shown in FIGS. 1 to 4. In the exemplary embodiment shown in FIG. 5 the contact legs 13, 14 each have only one spring slide, while in the plug-in contact according to FIGS. 1 to 4 the two contact legs 13, 14 are each formed by two spring slides which are located lying next to one another.

Even if only one electrical terminal 1 to which only one electrical lead 8 can be connected is shown in the figures, the terminal 1 in accordance with the invention is not limited thereto. Rather it is easily possible for several metal parts with several spring clips and several plug-in contacts to be located in one housing. The individual metal parts with the respective plug-in contacts can then be located in individual chambers of the overall housing so that the individual metal parts are insulated from one another and are located next to one another.

1-10. (canceled)

11. An electrical terminal comprising:
a housing:
a spring clip; and
a metal part,
wherein the spring clip includes a clamping leg and a contact leg,
wherein the clamping leg and a section of the metal part form a spring force clamp terminal for an electrical lead which is to be connected to the electrical terminal,
wherein a lead insertion opening for inserting the electrical lead and an actuation opening for opening the spring force clamp terminal are provided in the housing,
wherein the metal part is connected electrically and mechanically to a plug-in contact via at least one connecting region, and
wherein the plug-in contact has two contact legs which are resilient relative to one another for plugging into a contact hole of a circuit board.

12. The electrical terminal as claimed in claim 11, wherein:
the housing includes a first housing part and a second housing part, the first housing part being axially movable relative to the second housing part between a first position and a second position,
the spring clip and the metal part are located in the first housing part,
the contact legs of the plug-in contact are located to be axially movable in a chamber in the second housing part in a longitudinal direction of the chamber, and
the contact legs of the plug-in contact include free ends, wherein, in the first position of the first housing part, the free ends of the contact legs do not protrude from a bottom of the second housing part facing away from the first housing part, and, in the second position of the first housing part, the free ends of contact legs of the plug-in contact protrude from the bottom of the second housing part.

13. The electrical terminal as claimed in claim 12, wherein an end of the first housing part adjacent to the second housing part has a sleeve-shaped connecting region in which the second housing part is guided, wherein the first housing part includes at least one stop and the second housing part includes at least one corresponding counterstop, and wherein, in the second position of the first housing part, the stop adjoins the counterstop.

14. The electrical terminal as claimed in claim 13, wherein the sleeve-shaped connecting region of the first housing part includes at least one window which is engaged by a projection which extends radially and which is formed on the second housing part.

15. The electrical terminal as claimed in claim 14, wherein the projection includes a feed bevel and a step, wherein, in the first position of the first housing part, a first edge of the window adjacent the second housing part adjoins the step of the projection, while, in the second position of the first housing part, the first edge of the window is spaced apart from the step of the projection, and wherein a second edge of the window, which is farther away from the second housing part than the first edge of the window, adjoins the feed bevel of the projection.

16. The electrical terminal as claimed in claim 12, wherein the first housing part in its first position can be locked to the second housing part.

17. The electrical terminal as claimed in claim 12, wherein the first housing part includes at least one stop and the metal part includes at least one corresponding counterstop, and wherein the metal part in the first housing part is fixed in a position in a plug-in direction of the lead which is to be connected to the electrical terminal.

18. The electrical terminal as claimed in claim 11, wherein the bottom of the second housing part includes at least one adjusting element configured to be plugged into a corresponding recess in the circuit board.

19. The electrical terminal as claimed in claim 11, wherein the bottom of the second housing part includes a fixing element configured to be plugged into a corresponding recess in the circuit board.

20. The electrical terminal as claimed in claim 11, wherein the actuation opening includes an actuating pusher, which includes a first end, arranged to be moved out of a first position in which the spring force clamp terminal is closed into a second position in which the actuating pusher, with its first end facing the clamping leg, deflects the clamping leg against a spring force of the spring clip so that the spring force clamp terminal is opened.
